(19) United States
(12) Patent Application Publication
(10) Pub. No.: US 2006/0171769 A1
(43) Pub. Date: Aug. 3, 2006

(54) Tube style cosmetic container structure

(75) Inventor: Zhang Jun, Sijhih City (TW)

Correspondence Address: NIKOLAI & MERSEREAU, P.A., 900 SECOND AVENUE SOUTH, SUITE 820, MINNEAPOLIS, MN, 55402, US

(73) Assignee: CHUEN CHERN CO. LTD., Jhonghe City (TW)

(21) Appl. No.: 11/046,265

(22) Filed: Jan. 28, 2005

(51) Int. Cl. B43K 21/08

(52) U.S. Cl. 401/186; 401/183

(57) ABSTRACT

A tube style cosmetic container structure comprises a tube, in which liquid is contained, and an opening is arranged axially at one end, and a threaded part is arranged at the outskirt of the opening; an axle sleeve, one end of which is provided with a holding space, in which a resistant holding surface is formed, and a corresponding through material discharge hole is formed at an appropriate place of the outskirt of the other end, which is connected to the tube by being sleeved at the inside of the opening; A hollow piston rod, inside of which a protruding part is formed at a predetermined position, and a flanged disk is arranged at an appropriate position of the outside; one end of the flanged disk is provided with a snatch part, and a small diameter rod extends from the other end, and the rod, being sleeved a spring, is placed in the axle and move, to make the spring against the end surface formed by the resistant holding surface and the rod; A hollow sleeve pipe, one end of which is provided with a sleeving part to be firmly sleeved in the snatch part of the piston rod; A hollow pencil pipe, being sleeved by the sleeve pipe and snatched by the protruding part of the piston rod; an exterior cap, the exterior cap has a containing groove and a pressing flange, and can be screwed on the threaded part at the tube opening; when the upper cap is screwed on, the material discharge hole can be wholly locked, and no liquid will overflow from the material discharge hole even the tube is under certain pressure, while the upper cap is screwed off and the tube is squeezed to force the contents out, no squeezed contents will backflow even the pressure is reduced or stopped.

### BACKGROUND OF THE INVENTION

1. Field of the Invention

The present invention relates to a tube style cosmetic container structure, and more particularly to a cosmetic container that can prevent liquid overflow when its upper cap is tightly screwed on, and prevent liquid backflow when its upper cap is screwed off for usage, and can not only isolate air pollution, but also ease user's squeeze.

2. Description of Related Art

For a conventional cosmetic pencil, user shall firstly uncap it before dressing, then force cosmetic liquid to flow out in the direction of pencil head by means of holding the pencil rod by one hand, and turning the rotatable handle of the cosmetic pencil by another hand, and a dressing can be made. Therefore, the cosmetic pencil has to be used in a rotation way that complicates its application, and the cosmetic liquid might be polluted and quality degraded due to contacting the air.

According to above description, the known cosmetic pencil has such defects that it is inconvenient to use, liable to air pollution that affects quality. Therefore, a cosmetic container structure that can wholly eliminate aforementioned defects is made by the inventor according to his years of experience in the development and making of related products, and after careful research and active exploration as well as numerous tests and improvements in light of the problems occurring to existing cosmetic pencil.

### SUMMARY OF THE INVENTION

Thus, the main objective of the invention is to provide a tube style cosmetic container structure that can prevent liquid overflow when its exterior cap is tightly screwed on, and prevent liquid backflow when its exterior cap is screwed off for usage, and can also prevent cosmetic liquid being polluted by air.

In addition, another objective of the invention is to provide a tube style cosmetic container structure that facilitates user's squeeze and thus has advantage in usage.

To achieve above objectives, the present invention provides a tube style cosmetic container structure comprising:

A tube, in which cosmetic liquid is contained, and an opening is arranged axially at one end, and a threaded part is arranged at the outskirt of the opening.

An axle sleeve, one end of which is provided with a holding space, in which a resistant holding surface is formed; and a corresponding through material discharge hole is formed at an appropriate place of the outskirt of the other end, which is connected to the tube by being sleeved at the inside of the opening, wherein a large diameter round hole is concaved in the holding space, and resistant holding surfaces are formed at both ends of the round hole, while a resistant holding part protrudes circularly at the end part of the holding surface.

A hollow piston rod, inside of which a protruding part is formed at a predetermined position; and a flanged disk is arranged at an appropriate position of the outside; one end of the flanged disk is provided with a snatch part and a small diameter rod extends from the other end; the rod, being sleeved a spring, is placed in the axle and move, to make the spring against the end surface formed by the resistant holding surface and the rod; wherein, a concave part is circularly formed at an appropriate place between the piston rod and the protruding disk to allow the sleeving of an O-ring.

A hollow sleeve pipe, one end of which is provided with a sleeving part to be firmly sleeved in the snatch part of the piston rod; wherein an opposing surface is formed at the sleeving part of the sleeve pipe, and a cone is formed at the other end.

A hollow pencil pipe, being sleeved by the sleeve pipe and snatched by the protruding part of the piston rod; wherein the outskirt of one end of the pencil pipe is provided with a round concave part, and a through material discharge hole is formed axially at the other end, and a dressing purpose lipstick head can be held at the material discharge hole.

An exterior cap, which has a containing groove and a pressing flange, and can be screwed on the threaded part at the tube opening; wherein on the exterior cap, in correspondence with the threaded part, a snatch part is arranged, and a pressing flange is formed.

When the upper cap is screwed on, the material discharge hole will be wholly locked, and no liquid will overflow from the material discharge hole even when the tube is under certain pressure; while the upper cap is screwed off and the tube is squeezed to force the contents out, no squeezed contents will backflow even when the pressure is reduced or stopped. So the tube can not only be used conveniently, but can isolate air pollution, thus has advantage in usage.

In the following, other objects and functions of the invention are further illustrated by describing a preferred embodiment with reference to drawings and drawing numbers to make the details of the invention apparent to your honored Examination Committee, and enable those skilled in the art to implement thereby. Following description to the preferred embodiment is only illustrative, and not designed to restrict the range of the invention, thus any form of variations or amendments to the invention based on the spirit of the invention are to be embraced within this scope.

### BRIEF DESCRIPTION OF THE DRAWINGS

FIG. 1 is a perspective view of a tube style cosmetic container in accordance with the present invention;

FIG. 2 is an exploded perspective view of the tube style cosmetic container in FIG. 1;

FIG. 3 is a cross-sectional view of the tube style cosmetic container in FIG. 1;

FIG. 4 is an operational view of the tube style cosmetic container when screwed on;

FIG. 5 is an operational view of the tube style cosmetic container when uncapped.

### DETAILED DESCRIPTION OF THE INVENTION

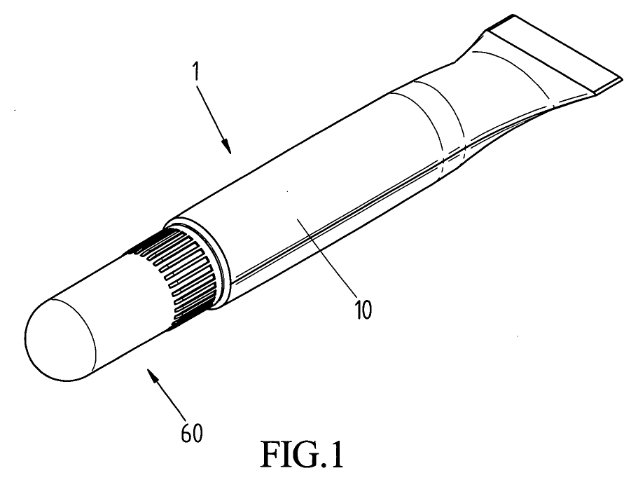

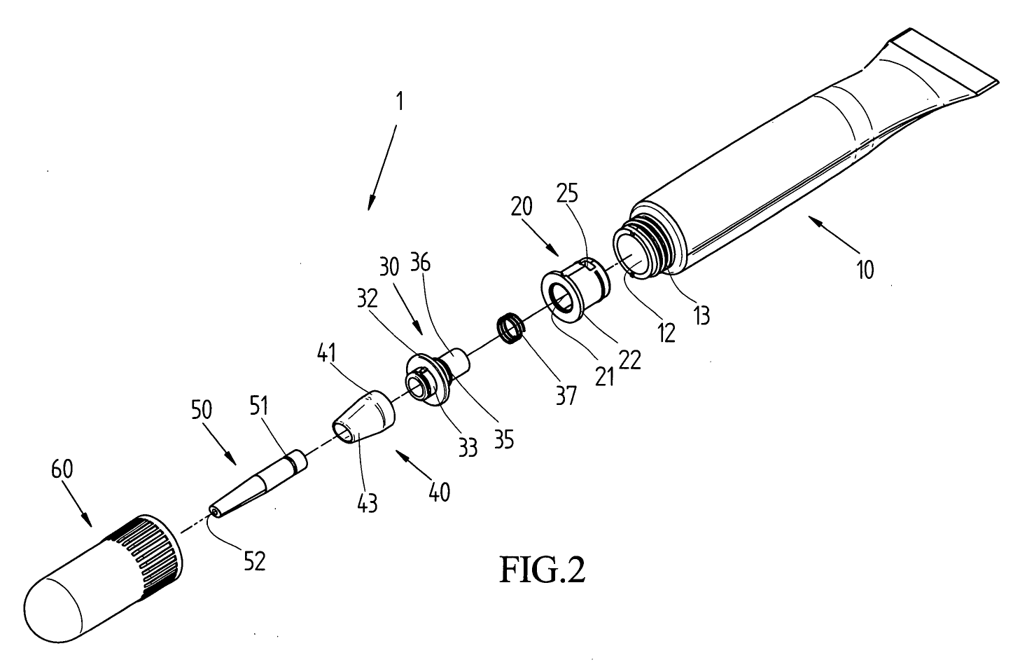

As shown in FIG. 1-3, the invention is a tube style cosmetic container (1), which includes:

A tube (10), in which cosmetic liquid (11) is contained, and an opening (12) is arranged axially at one end, and a threaded part (13) is arranged at the outskirt of the opening.

An axle sleeve (20), one end of which is provided with a holding space (21), and a resistant holding part (22) protrudes circularly at the end flange, and the resistant holding part (22) is sleeved at the end flange of the opening (12); in addition, a large diameter round hole (23) is concaved in the holding space (21), and resistant holding surfaces (24) are formed at both ends of the round hole (23); while for the other end of axle sleeve (20), a corresponding through material discharge hole (25) is formed at an appropriate place of the outskirt, and the material discharge hole (25) is connected to the cosmetic liquid (11) of tube (10).

A hollow piston rod (30), inside of which a protruding part (31) is formed at a predetermined position; and a flanged disk (32) is arranged at an appropriate position of the outskirt of one end; one end of the flanged disk (32) of piston rod (30) is provided with a snatch part (33), and a concave part (34) is circularly formed at the other end to allow the sleeving of an O-ring (35), and a small diameter rod (36) extends from the end of concave part (34) so as to sleeve spring (37), and is placed in the holding space (21) and move, to make spring (37) against the end surface of resistant holding surface (24) and rod (36).

A hollow sleeve pipe (40), one end of which is provided with a sleeving part (41), and an opposing surface (42) is formed in the sleeving part (41) so as to sleeve the snatch part (33) of piston rod (30); and a cone (43) is formed at the other end of sleeve pipe (40).

A hollow pencil pipe (50), a round concave part (51) being provided at the outskirt of one end to allow pencil pipe (50) to be sleeved by sleeve pipe (40) and snatched by the protruding part (31) of piston rod (30), and a through material discharge hole (52) is formed axially at the other end.

Wherein a dressing purpose lipstick head (53) can be held at the material discharge hole (52).

An exterior cap (60), the exterior cap (60) has a containing groove (61), which can be screwed on the threaded part (13) at the tube opening (12) of tube (10); and in correspondence with threaded part (13), a snatch part (62) is arranged, and a pressing flange (63) is formed.

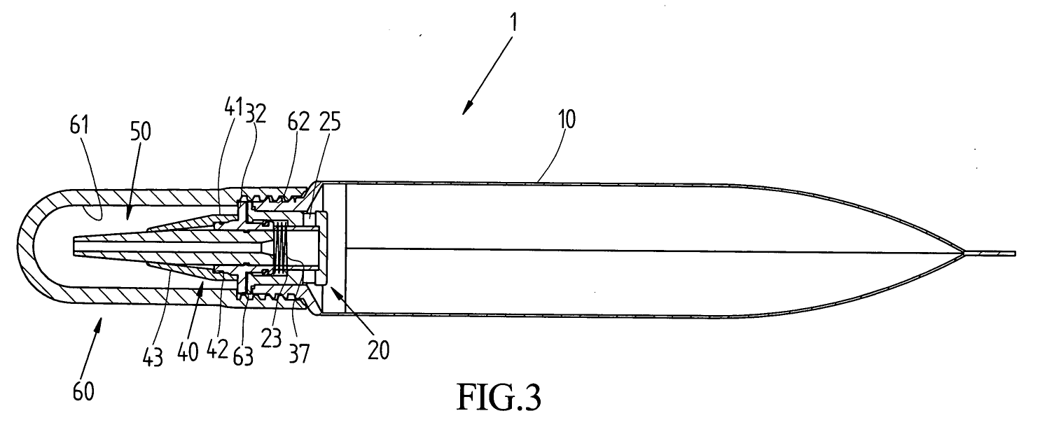

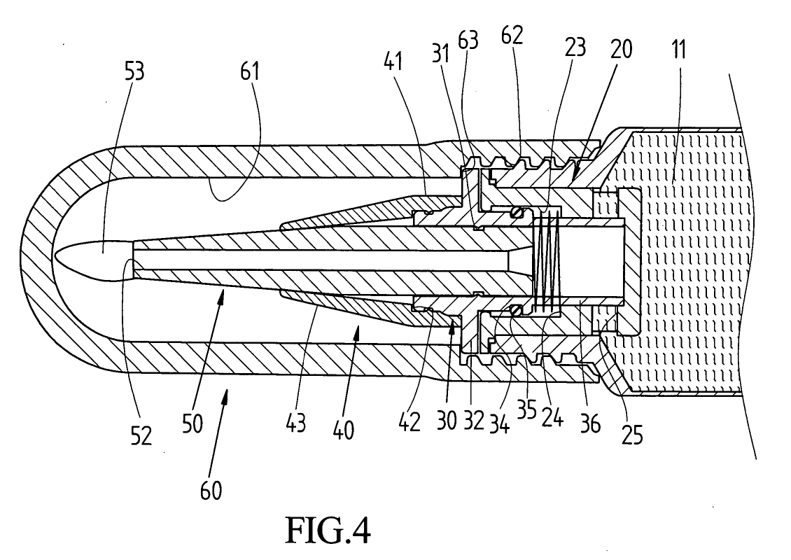

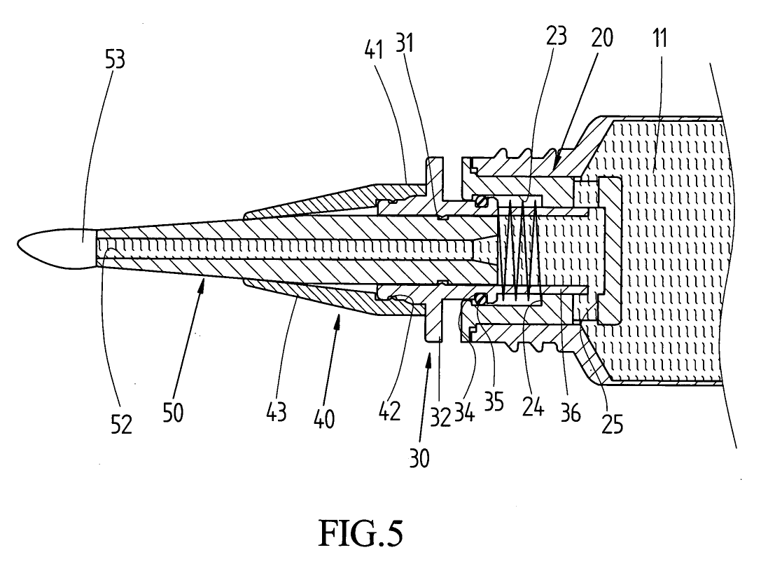

According to above combination, as shown in FIGS. 3-5, when the pencil is not for use, the exterior cap (60) can be screwed on, at the moment, the flanged disk (32) of piston rod (30) can be pressed by the pressing flange (63) of exterior cap (60), enabling flanged disk (32) to be on the end surface of the resistant holding part (22), and make the rod (36) of piston rod (30) compress spring (37), thus the rod (36) will move to the bottom of the holding space (21) of axle sleeve (20) and seal the material discharge hole (25) to fail the cosmetic liquid (11) in the tube (10) to flow out. Therefore, when the upper cap is screwed on, the material discharge hole can be wholly locked, and no liquid will overflow from the material discharge hole (25) even tube (10) is under certain pressure.

In addition, during using cosmetic container (1), when the exterior cap (60) is screwed off, the piston rod (30) will bounce for 1-2 mm under the force of spring (37), and now after the tube (10) is squeezed, the cosmetic liquid (11) will flow into the holding space (21) via material discharge hole (25), then enter into the interior of piston rod (30), and finally flow out via the material discharge hole (52) of pencil pipe (50). Therefore, using the action of piston rod (30) and spring (37), as well as the pressing of exterior cap (60), when the upper cap (60) is screwed off and the tube (10) is squeezed to force the contents out, no squeezed contents will backflow even the pressure is reduced or stopped.

In general, we know the invention has following advantages:

1) The invention can prevent liquid overflow when the exterior cap (60) is tightly screwed on and prevent liquid backflow when the exterior cap (60) is screwed off for usage, and thus is airtight, so as to prevent cosmetic liquid (11) being polluted by air.

2) The tube (10) of the invention is easy to squeeze, and facilitates user's usage by using the action of piston rod (30) and spring (37), as well as the pressing of exterior cap (60).

Although the invention has been explained in relation to its preferred embodiment, it is to be understood that many other possible modifications and variations can be made without departing from the spirit and scope of the invention as hereinafter claimed.

What is claimed is:

1. A tube style cosmetic container comprising:
a tube, in which liquid is contained, and an opening is arranged axially at one end, and a threaded part is arranged at the outskirt of the opening;
an axle sleeve, one end of which is provided with a holding space, in which a resistant holding surface is formed; and a corresponding through material discharge hole is formed at an appropriate place of the outskirt of the other end, which is connected to the tube by being sleeved at the inside of the opening;
a hollow piston rod, inside of which a protruding part is formed at a predetermined position; and a flanged disk is arranged at an appropriate position of the outside; one end of the flanged disk is provided with a snatch part, and a small diameter rod extends from the other end; the rod, being sleeved a spring, is placed in the axle and move, to make the spring against the end surface formed by the resistant holding surface and the rod;
a hollow sleeve pipe, one end of which is provided with a sleeving part to be firmly sleeved in the snatch part of the piston rod;
a hollow pencil pipe, being sleeved by the sleeve pipe and snatched by the protruding part of the piston rod;
an exterior cap, the exterior cap has a containing groove and a pressing flange, and can be screwed on the threaded part at the tube opening;

2. A tube style cosmetic container as claimed in claim 1, wherein the cosmetic liquid is contained in the tube.

3. A tube style cosmetic container as claimed in claim 1, wherein a large diameter round hole is concaved in the holding space, and resistant holding surfaces are formed at both ends of the round hole, while a resistant holding part protrudes circularly at the end part of the holding surface.

4. A tube style cosmetic container as claimed in claim 1, wherein a concave part is circularly formed at an appropriate place between the piston rod and the protruding disk to allow the sleeving of an O-ring.

5. A tube style cosmetic container as claimed in claim 1, wherein an opposing surface is formed at the sleeving part of the sleeve pipe, and a cone is formed at the other end.

6. A tube style cosmetic container as claimed in claim 1, wherein the outskirt of one end of the pencil pipe is provided with a round concave part, and a through material discharge hole is formed axially at the other end.

7. A tube style cosmetic container as claimed in claim 1, wherein a snatch part is arranged and a pressing flange is formed on the exterior cap in correspondence with the threaded part.

8. A tube style cosmetic container as claimed in claim 6, wherein a dressing purpose lipstick head can be held at the material discharge hole.
